(19) United States
(12) Patent Application Publication
(10) Pub. No.: US 2013/0291014 A1
(43) Pub. Date: Oct. 31, 2013

(54) METHOD AND SYSTEM FOR UNIFORMLY MARKING AND IDENTIFYING PLACEMENT OPPORTUNITY LOCATIONS FOR FACILITATING ACCELERATED DECISION RESOLUTION

(71) Applicants: John Raymond Mick, JR., Sunnyvale, CA (US); Jeffrey Sherwin, Scarsdale, NY (US)

(72) Inventors: John Raymond Mick, JR., Sunnyvale, CA (US); Jeffrey Sherwin, Scarsdale, NY (US)

(21) Appl. No.: 13/459,382

(22) Filed: Apr. 30, 2012

(51) Int. Cl. H04N 21/236

(52) U.S. Cl. 725/34

(57) ABSTRACT

A computer implemented method and system of marking signal streams for advertisement placement is disclosed. A server receives at least one source signal stream having a channel identifier. The server identifies an advertisement signal point in the at least one source signal stream. The server determines a temporal starting location of the advertisement signal point. The server generates a unique signal ID based on the temporal starting location of the advertisement signal point and the channel identifier. The server inserts the unique signal ID into metadata of the at least one source signal stream. The unique signal ID may be a universal unique identifier (UUID).

### FIELD OF THE INVENTION

The present invention relates generally to service provider video networks, and more particularly to a method and system for uniquely marking and identifying placement opportunity locations for facilitating accelerated decision resolution in signal streams.

### BACKGROUND OF THE INVENTION

Traditionally, programming of broadcast and cable television and radio, including content (i.e., the video or audio program) and (the placement of) ads in a video or audio signal stream, has followed a linear model. Programming may be linear in the sense that a program begins and is streamed and in progress when a user chooses to view entertainment content. FIG. 1 illustrates a conventional linear or video-on-demand (VOD) model for advertisement placement. Entertainment content 2, when processed as a digital data stream over a cable network, may be divided into a number of time intervals. The time intervals 4 include time reserved for a viewed program (content), such as “Golden Girls.” The intervals 6, 8, 10, represent sections of time reserved for advertisements or “avails.” These “avails” may be viewed as advertisement placement opportunities. As used herein, a “placement opportunity” was traditional called an avail and is sometimes referred to as a slot (spots into slots). A placement opportunity (PO) is a construct that represents an opportunity to insert an advertisement or entertainment content, and defines the rules for that opportunity, such as its duration, interactivity, ownership, and technical constraints.

As used herein, the term “binding” refers to an identification of signals and content within a placement opportunity (PO). PO's are frequently created for broad amounts of content that are not yet published (i.e., any show on TNT network in the evening). When the show airs and a signal is detected, the signal is bound to the relevant PO's for that show.

As used herein, the term “impression” refers to a showing of an advertisement to a single viewer. For example, if a 30 second spot is placed in 50,000 video-on-demand (VOD) streams and it is known that 30,000 of the streams actually played the ad, then 30,000 impressions of that advertisement have been generated.

As used herein, a “status notification” may be, but is not limited to, an HTTP call from a VOD server with a unique ID that was created when a decision was delivered.

As used herein, the term “break” refers to all of the space in a stream between entertainment content. For example, a group of 4 consecutive 30 second spots between 2 segments of “Two and a Half Men” may be considered as a single break.

As used herein, an estimated starting location of a break in a signal stream is referred to as a signal point. In the context of advertisement placement, these signal points may be referred to as advertisement signal points.

In non-linear systems, such as Video-on-Demand (VOD), the intervals 6, 8, 10 may take on new meanings. The interval 6 is called a pre-roll, i.e., the space in a video that occurs immediately after a user clicks to start a VOD video. The interval 10 is known as a post-roll, i.e., the space after all of the VOD video segments have finished playing. The intervals 8 may be mid-rolls, i.e., mini-breaks in the middle of a VOD video, or may be interstitials, i.e., pod-like locations between consecutive VOD video segments. VOD advertisement placement opportunities may appear based on space, time, content, and user context and may be highly non-linear (i.e., the user chooses to initiate the playing of content and in response, the content starts). All of the intervals 6, 8, 10 in such play lists are ripe for the insertion of advertisements, i.e., advertisement placement opportunities.

FIG. 2 depicts a configuration of a conventional Internet-based cable television infrastructure 200 for performing advertising placement decisions in signal streams. On TV, the advertising network was formerly the national network, the cable network, or the cable operator. However, unlike the Internet, where browsers access/display content and then are separately “referred” to a shared advertisement network, the Internet-based cable television infrastructure 200 selects and assembles both the advertisement and the content together and delivers the combined result to customers' “smart appliances” 202a-202n (e.g., Internet ready televisions, radios, smartphones, tablets, PCs, etc.).

Recently, smart appliances 202a-202n, such as Internet-ready televisions, have become capable of receiving content from Internet streaming services, such as Netflix movies, Pandora streaming radio, etc., over WiFi or direct Ethernet connections. When a user clicks on an icon for an “app” that appears on the television set corresponding to one of these services, the content is streamed to the smart appliance 202a-202n from a content delivery network (CDN) 204 directly to the application running in the smart appliance 202a-202n without the need for a set top box.

A set top box may be configured to decode an analog representation of two states of a digital signal, as is known in the art, that is continuously streamed and pushed to the set top box through a broadcast facility over a coaxial or fiber optic cable and the set top box tunes to that channel and displays the content. When a user watches Internet-delivered program content, a browser within the smart appliance 202a-202n fetching video in predetermined time chunks—generally two sometimes three, sometimes ten second chunks. The fetched chunks of video are seamlessly stitched together dynamically in the app software and then displayed so as to appear as a smooth video on the smart appliance 202a-202n.

A Multiple System/Service Operator (MSO—a cable TV organization that owns more than one cable system and may prove broadband Internet service) may wish to rebroadcast video streams on smart appliances. Unfortunately, every connected device, including smart appliances, needs to obtain video in the format that it can consume. Apple, Microsoft, Adobe, etc., have very specific and incompatible formats. To overcome this problem, each of these companies has constructed facilities called content deliver networks (CDN) 204 where a “set top box” for each channel is configured to receive broadcasts from satellites. A signal received by a “set top box” from upstream devices 206 is fed to a transcoder 208 to place the signal in a desired format and to fragment the formatted signal into the predetermined (e.g., 2 second) chunks of data. These chunks are then stored at the CDN 204 on server farms located physically close to where the content is to be delivered.

To identify a particular channel data stream, including times when a program has ended and before the next program begins, i.e., a placement opportunity, a q-tone is inserted in the channel data stream a predetermined time before the next program begins. An observer 210, which may be the transcoder 208, informs an advertisement service (ADS) 212 of the arrival of the q-tone for subsequent placement of one or more advertisements into the channel data stream. The advertisement service 212, in turn, is waiting for the subsequent arrival of requests from a CDN 204 to place advertisements into breaks in the channel data stream.

The q-tone may be an instance of an SCTE-35 packet. An SCTE-35 packet may include an identifier of 16 to 32 bits in length. Unfortunately, this identifier is not large enough to identify an individual placement opportunity in an individual signal stream for advertisement placement decisions and other processes. Therefore, it is necessary to identify information that may be located in data stores using multi-parameter relational queries or look-ups. This slows system performance considerably.

Unfortunately, multi-parameter requests may lead to congestion, dropped requests, and re-boots if an advertisement service is flooded with requests. This is particularly true of national-based television programming, where tens of thousands to millions of requests for advertisements may flood a single or a few advertisement services substantially simultaneously.

Accordingly, what would be desirable, but has not yet been provided, is a method and system for uniquely marking and identifying placement opportunity locations for facilitating accelerated decision resolution in signal streams.

### SUMMARY OF THE INVENTION

The above-described problems are addressed and a technical solution is achieved in the art by providing a computer implemented method and system of marking signal streams for advertisement placement. A server receives at least one source signal stream having a channel identifier. The server identifies an advertisement signal point in the at least one source signal stream. The server determines a temporal starting location of the advertisement signal point. The server generates a unique signal ID based on the temporal starting location of the advertisement signal point and the channel identifier. The server inserts the unique signal ID into metadata of the at least one source signal stream. The unique signal ID may be a universal unique identifier (UUID). The universally unique identifier may be at least 128 bits in length. The unique signal ID may inserted into the metadata of the at least one source signal stream using a designated in-band carriage format. The temporal starting location of an advertisement signal point may be determined based on a wall clock time stamp.

In one embodiment, identifying an advertisement signal point in the at least one source signal stream may comprise receiving an instance of an SCTE-35 packet indicative of a cue tone.

In one embodiment, the method may further comprise generating at least one theoretical advertisement placement opportunity based on the identified advertisement signal point. At least one confirmed advertisement placement opportunity may be obtained from the at least one theoretical advertisement placement opportunity. Obtaining the at least one confirmed advertisement placement opportunities from the at least one theoretical advertisement placement opportunity may comprise pre-allocating at least one premade, but unconfirmed advertisement placement opportunity without signals; binding the source signal stream to at least one premade, but unconfirmed advertisement placement opportunity; and, designating the at least one premade, but unconfirmed advertisement placement opportunity as confirmed advertisement placement opportunity.

In one embodiment, the method may further comprise performing an advertisement decision for the at least one confirmed advertisement placement opportunity. Performing an advertisement decision for the at least one confirmed advertisement placement opportunity may comprise transmitting, to an advertisement decision service, an advertisement call with the unique signal ID for the at least one confirmed advertisement placement opportunity; receiving, from the advertisement decision service, at least one advertisement targeted to at least one recipient signal stream; inserting the at least one targeted advertisement and the unique signal ID into the at least one recipient signal stream; and transmitting the at least one recipient signal stream to at least one recipient.

In one embodiment, the method may comprise employing the temporal starting location of the advertisement signal point with the unique signal ID to perform a lookback lookup.

In one embodiment, the method may comprise generating a look-ahead decision trigger with the unique signal ID as trigger data. The method may further comprise transmitting to an advertisement decision service an advertisement call with the unique signal ID for at least one confirmed advertisement placement opportunity. In response to transmitting to an advertisement decision service an advertisement call with the unique signal ID, the server may perform advertisement decision may for at least one confirmed placement opportunity, further comprising: receiving, from an advertisement decision service, at least one advertisement targeted to at least one recipient signal stream; inserting the at least one targeted advertisement and the unique signal ID into the at least one recipient signal stream; and storing the at least one targeted advertisement in a cache. The at least one targeted advertisement may be stored in a cache, which may be a JAR.

### BRIEF DESCRIPTION OF THE DRAWINGS

The present invention will be more readily understood from the detailed description of exemplary embodiments presented below considered in conjunction with the attached drawings, of which:

FIG. 1 illustrates a conventional linear or video-on-demand model for advertisement placement;

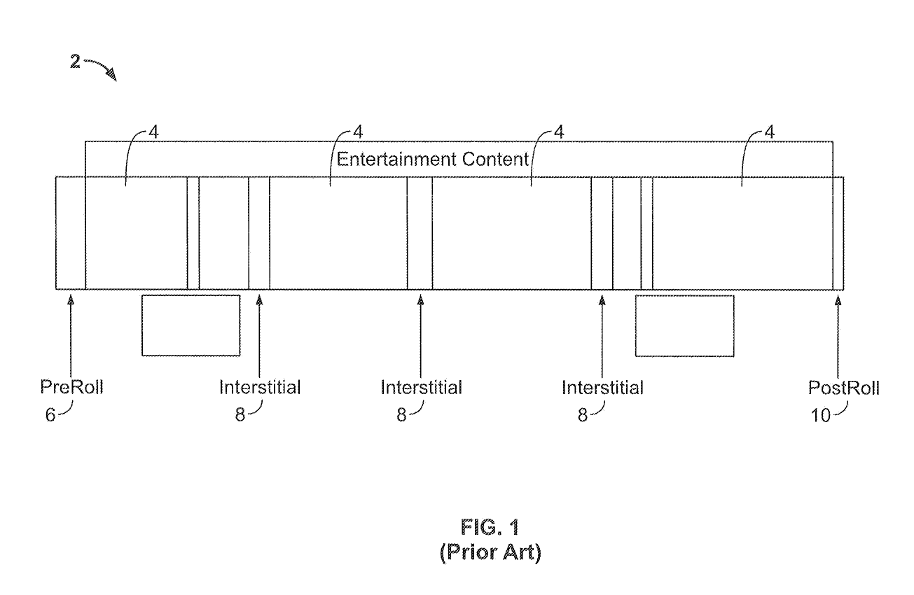

FIG. 2 depicts a configuration of a conventional Internet-based cable television infrastructure for performing advertising placement decisions in signal streams;

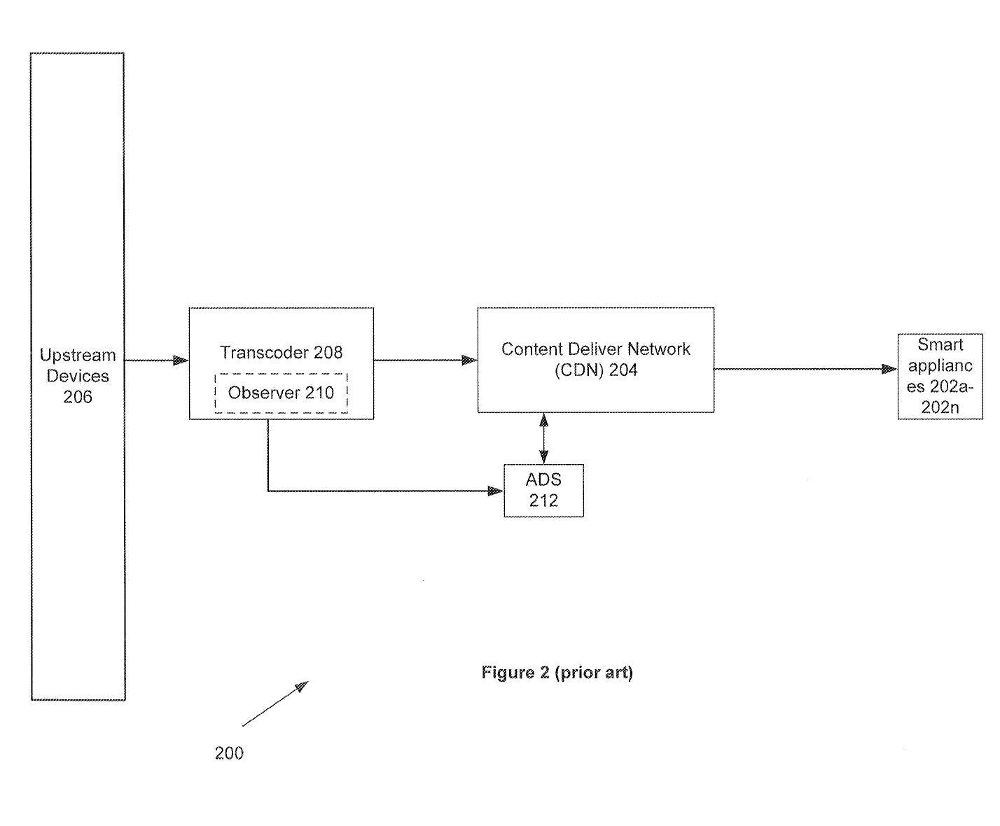

FIG. 3 depicts a configuration of one embodiment of a system for marking signal streams for advertisement placement, according to an embodiment of the present invention;

FIG. 4 is a flow diagram illustrating one embodiment of a method of marking signal streams for advertisement placement, according to an embodiment of the present invention;

FIG. 5 is a flow diagram illustrating one embodiment of a method for performing an advertisement decision for at least one confirmed advertisement placement opportunity, according to an embodiment of the present invention;

FIG. 6 depicts a configuration of a system for accelerating advertising placement decisions in signal streams, according to an embodiment of the present invention;

FIG. 7 is a flow diagram illustrating one embodiment of a method for accelerating advertising placement decisions in signal streams from the point of view of a server, according to an embodiment of the present invention;

FIG. 8 is a flow diagram illustrating one embodiment of a method for accelerating advertising placement decisions in data streams from a point of view of one of a client, according to an embodiment of the present invention; and

FIG. 9 illustrates a diagrammatic representation of a machine in the exemplary form of a computer system within which a set of instructions, for causing the machine to perform any one or more of the methodologies discussed herein, may be executed.

It is to be understood that the attached drawings are for purposes of illustrating the concepts of the invention and may not be to scale.

### DETAILED DESCRIPTION OF THE INVENTION

Certain embodiments of the present invention are compatible with and make use of elements defined according to the SCTE-130 standard. The SCTE-130 standard provides a standardized and extensible message based interface defining a minimal set of cooperating logical services necessary to communicate placement opportunities, placement decisions, and placement related event data necessary for accountability measurements. SCTE-130 defines an extensible framework of interfaces among a set of advertising system logical services. The SCTE-130 standard encompasses: a minimal set of cooperative logical services needed to implement advanced addressable advertising systems; the core data types and extensible message framework forming a vocabulary needed to communicate among the defined logical services; the interfaces among these logical services using the core data types and messages; and, mechanisms for extensibility that allow innovation while preserving backward compatibility with already deployed systems—thereby reducing the complexity for incorporating new features within the standard.

The normative parts of the SCTE-130 standard define mechanisms for integrating systems implementing features such as VOD-based advertising, linear-based advertising, enhanced advertising capabilities such as advertisement rotation groups (rotation groups refer to placement opportunities that run in rotation so that the same ad is not viewed again immediately), subscriber-based addressing for advertising or content tailoring, extension points for more advanced advertising or addressing features, logical services that are implemented as one or more physical systems created by the same vendor, deployment of a logical service that may simultaneously include systems from one or more vendors, and an implementation that may incorporate one or more of the defined logical services and interfaces

The SCTE-130 standard defines a set of logical services comprising an advanced advertising system. Each logical service may itself be a complex system. In an embodiment, one or more of the following logical services may be used by or interact with certain embodiments of the present invention.

An Advertisement Management Service (ADM) defines messages in support of advertisement insertion activities. The primary consumer of these messages is an Advertisement Decision Service (ADS). The message interfaces exposed by an ADM permit both pre-configured advertisement decisions as well as real-time fulfillment models. An ADM implementation may incorporate some simple advertisement selection rules (e.g., advertisement rotations) but more complex advertisement decisions are the responsibility of an ADS.

An Advertisement Decision Service (ADS) determines how advertising content is combined with non-advertising (i.e., entertainment) content assets. The decisions made by an ADS may be straightforward (i.e., specific advertisement content placed at a specific time in a specific asset) or arbitrarily complex (based on subscriber data, advertising zone, etc.).

A Content Information Service (CIS) manages metadata describing assets (both advertising assets and non-advertising assets) available to the other SCTE-130 logical services. The CIS provides query and notification interfaces to the other logical services. The query service is available on an ad-hoc basis and may be called by any other logical service at any time without any prior registration. Queries specify values or patterns to be sought in the query message metadata and the specified matching information (or an error indication) is returned in a response message.

The Content Information Service (CIS) is a storage and distribution engine. It stores metadata about entertainment and advertising assets; provides notifications to registered clients when metadata is modified; registers, receives and processes notifications from other CIS services; and supports real-time metadata queries. The CIS permits an Advertising Manager (ADM) and/or Advertisement Decision Service (ADS) to retrieve and utilize content metadata in their advanced advertising decision processing.

A Placement Opportunity Information Service (POIS) may hold, maintain, and retain descriptions of placement opportunities. The POIS may also contain attributes and constraints for each placement opportunity, platform compliance, rights, and policies of the content in which the placement opportunity exists. These placement opportunities are content specific, therefore attributes and constraints may vary by network, geographic region, or other content distribution dimension.

The POIS is a Placement Opportunity (PO) storage and inventory execution engine. It stores PO metadata and statistics; provides notifications to registered clients when PO metadata is modified; registers, receives and processes notifications from other POIS services; and supports real-time PO metadata queries. Through the POIS appliance, an Advertising Manager (ADM) and/or Advertisement Decision Service (ADS) can retrieve and utilize placement opportunity metadata in their advanced advertising decision making.

The Subscriber Information Service (SIS) manages per-subscriber information relevant to advertisement placement decisions. The SIS provides a mapping between subscriber or client identifiers, such as a MAC address, serial number, etc., and subscriber or audience attributes, e.g., age, sex, location of a subscriber.

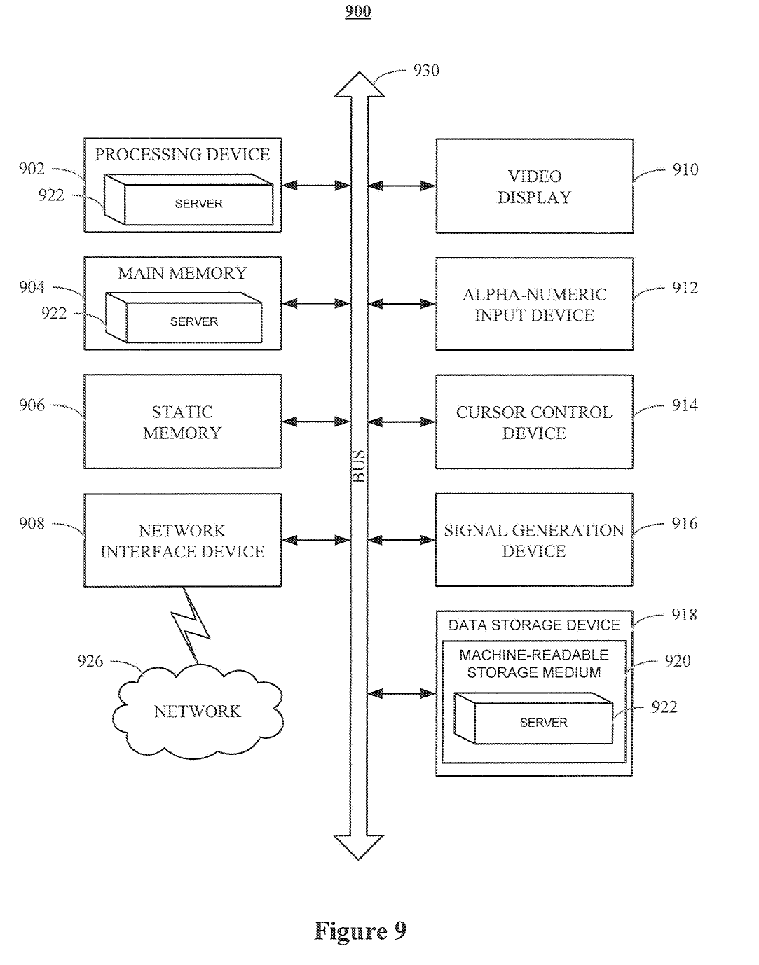

The term “computer” or “computer platform” is intended to include any data processing device, such as a desktop computer, a laptop computer, a tablet computer, a mainframe computer, a server, a handheld device, a digital signal processor (DSP), an embedded processor (an example of which is described in connection with FIG. 9), or any other device able to process data. The computer/computer platform is configured to include one or more microprocessors communicatively connected to one or more non-transitory computer-readable media and one or more networks. The term “communicatively connected” is intended to include any type of connection, whether wired or wireless, in which data may be communicated. The term “communicatively connected” is intended to include, but not limited to, a connection between devices and/or programs within a single computer or between devices and/or separate computers over a network. The term “network” is intended to include, but not limited to, OTA (over-the-air transmission, ATSC, DVB-T), packet-switched networks (TCP/IP, e.g., the Internet), satellite (microwave, MPEG transport stream or IP), direct broadcast satellite, analog cable transmission systems (RF), and digital video transmission systems (ATSC, HD-SDI, HDMI, DVI, VGA), etc.

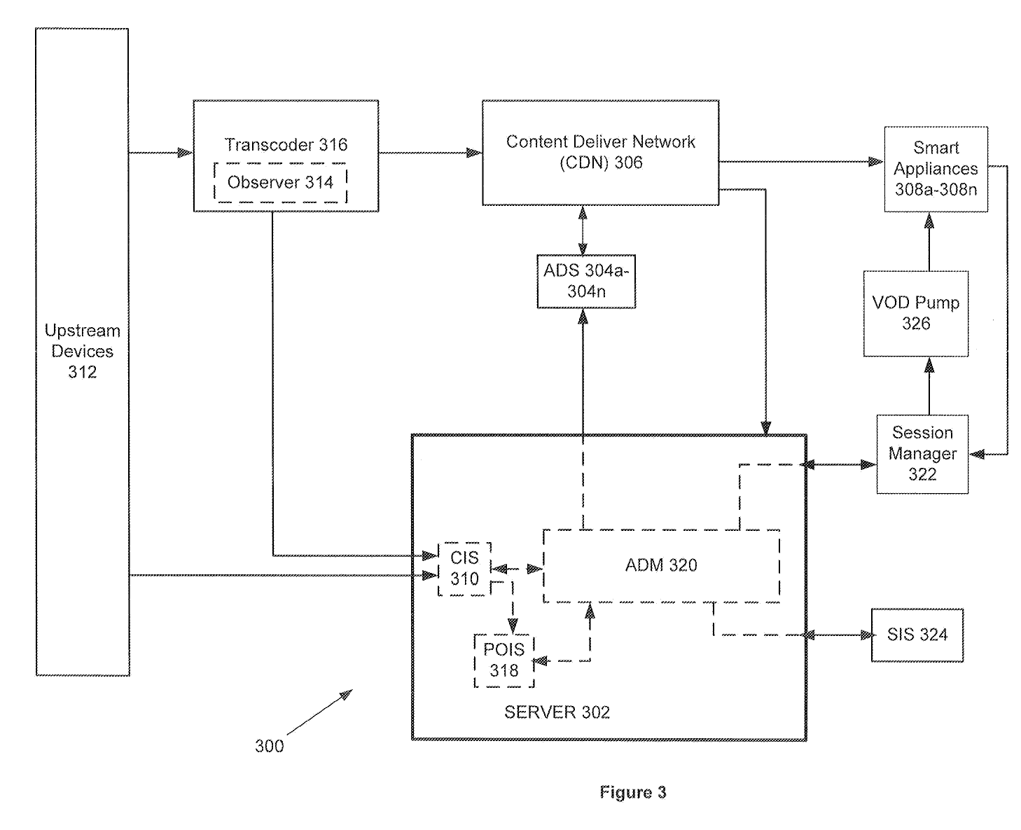

FIG. 3 depicts a configuration of a system 300 for marking signal streams for advertisement placement, according to an embodiment of the present invention. The system 300 may be executed on a server 302, interconnected by one or more networks (not shown) and communicatively connected to one or more ADSs 304a-304n. The ADSs 304a-304n are configured to place advertisements into advertisement breaks in recipient data streams at the request of a CDN 306 for delivery to one or more smart appliances 308a-308n.

The server 302 may be associated with or implement a CIS 310 for receiving one or more source signal streams from upstream devices 312 and corresponding q-tones (i.e., instances of SCTE-35 packets) from an observer 314, which may be incorporated within a transcoder 316. The transcoder 316 is also configured to deliver IP video, audio, etc. in predetermined “chunks” to a CDN 306 as described above.

The CIS 310 is also configured to identify metadata from the one or more source signal streams and deliver the identified metadata to the server 302. The server 302 is configured to pre-allocate a corresponding number of unconfirmed placement opportunities without signals and to bind the source signal stream to a plurality of premade, but unconfirmed placement opportunities. Part of the identified metadata includes a channel identifier associated with a corresponding source signal stream. The CIS 310 is configured to return a globally unique value, a UUID, referred to as a signal identifier or signal ID that uniquely identifies a PO as a confirmed PO and its starting location within the end-to-end operational system 300. The CIS 310 is further configured to insert the signal ID and the channel identifier into the metadata of the source signal stream using the appropriate in-band carriage format.

In one embodiment, a POIS 318 may be implemented by the server 302. The POIS 318 is configured to “confirm” unconfirmed placement opportunities by identifying temporal starting locations of the unconfirmed placement opportunities (i.e., including advertisement signal point(s)) relative to both the content stream and a wall clock.

In one embodiment, the POIS 318 may be configured to initiate a workflow in an instance of an SCTE 130 Advertisement Management Service 320, or ADM 320 associated with the server 302 to identify a list representative of a number of recipient signal streams having the channel identifier and at least one audience attribute. To identify the list, the ADM 320 places a call each to an external session manager 322 and an SIS 324. The ADM 320 transmits the channel identifier to the session manager 322, which provides the ADM 320 with a list of client identities indicative of a number of recipients currently viewing a channel corresponding to the channel identifier. The ADM 320 transmits the list of client identities and the channel identifier to the SIS 324 which provides the ADM 320 with a list of sets of audience qualifiers correlated to the client identities and the channel identifier. This list of sets of audience qualifiers correlated to the client identities and the channel identifier is representative of a list of recipient signal streams having the same channel identifier that are currently being “watched” by subscribers, where each subscriber in the list has a certain set of audience attributes (e.g., all males 21 and over). The ADM 320 is also configured to obtain a plurality of targeted advertisements corresponding to the list sets of audience qualifiers correlated to the client identities and the channel identifier from one or more of the ADSs 304a-304n. The ADM 320 receives, from the ADSs 304a-304n, the plurality of advertisements targeted to the list representative of the plurality of recipient signal streams.

The ADM 320 uses the unique signal ID plus a set of locally configured or learned targeting criteria to initiate a unique set of advertisement decision requests. The advertisement decision requests evolve into targeted advertisement decision requests to the appropriate decision owners (i.e., the ADSs 304a-304n) and the results are a set of advertisement placement decisions correlating to the placement opportunities generated as a result of signal confirmation.

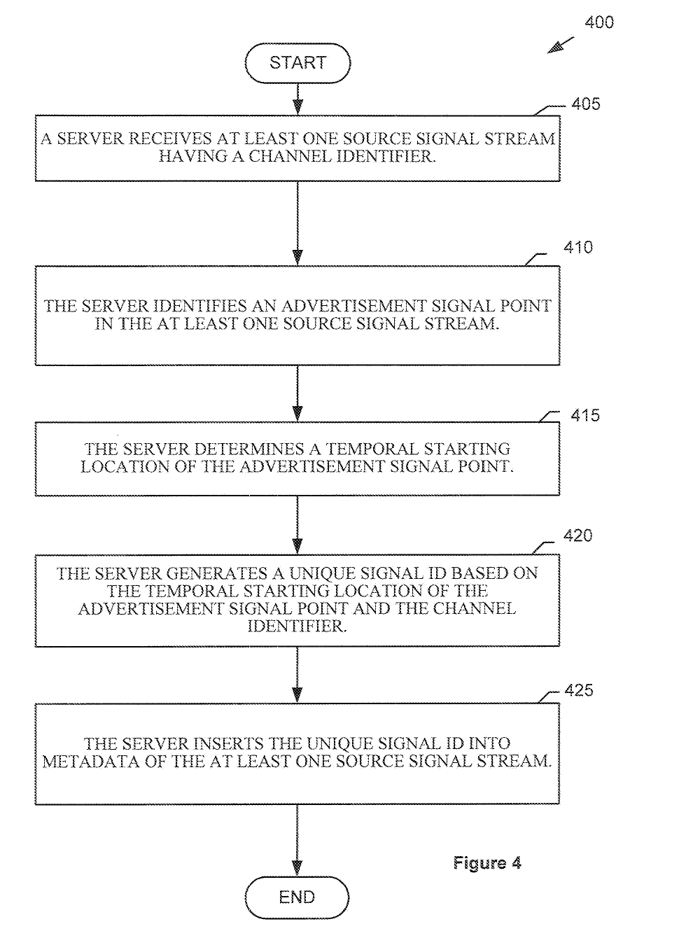

FIG. 4 is a flow diagram illustrating one embodiment of a method 400 of marking signal streams for advertisement placement, according to an embodiment of the present invention. At block 405, the server 302 receives at least one source signal stream having a channel identifier. The CIS 310 associated with the server 302 receives a source signal stream (e.g., in MPEG-2 format) having a channel identifier from the upstream devices 312. The CIS 310 identifies metadata from the source signal stream including the channel identifier and presents the channel identifier to the server 302.

At block 410, the server 302 identifies an advertisement signal point in the at least one source signal stream. In one embodiment, identifying an advertisement signal point in a source signal stream may be based on receiving an external notification of an arrival of the signal point in the corresponding source signal stream. The transcoder 316 associated with a specific vendor format for the source signal stream (e.g., TBS) receives the source signal stream and converts the source signal stream to IP video. In the process, the observer 314, which may be included in transcoder 316, notes the presence of an SCTE-35 q-tone.

In one embodiment, the notification is an instance of an SCTE-35 packet indicative of a q-tone tone prior to a corresponding signal point located in the source signal stream. The q-tone also provides an indication that a theoretical advertisement placement opportunity is located in the source signal stream a time period prior to a theoretical advertisement signal point in the source signal stream. The observer 314 of the transcoder 316 then places a web call to the CIS 310 to inform the CIS 310 that the q-tone for a specific channel identifier has been observed. The SCTE-35 packet and a channel identifier are extracted from metadata of the source signal stream by the CIS 310 and delivered to the server 302.

At block 415, the server 302 determines a temporal starting location of the advertisement signal point in the at least one source signal stream. The temporal starting location of an advertisement signal point in the at least one source signal stream may be determined by the CIS 310 based on confirming theoretical placement opportunities located in the source signal stream. The temporal starting location of the advertisement signal point may be based in part on a wall clock time stamp.

The arrival of the SCTE-35 packet is an indication of a number of theoretical advertisement placement opportunities (POs) for the specified channel ID (e.g., TBS). Each unconfirmed PO has an estimated starting location known as an advertisement signal point. The advertisement signal point needs to be confirmed. When an actual advertisement insertion starting location is encountered in real-time in the source signal stream, a software process in the POIS 318 confirms the actual time of the advertisement signal point. This confirmed advertisement signal point results in the generation of confirmed POs that are now ready for advertisement insertion in at least one recipient signal stream.

When the POIS 318 receives the theoretical placement opportunities, the POIS 318 is configured to pre-allocate a corresponding number of unconfirmed advertisement placement opportunities without signals and to bind the source signal stream to a plurality of premade, but unconfirmed advertisement placement opportunities. Binding the source signal stream to a plurality of premade, but unconfirmed advertisement placement opportunities includes the CIS 310 identifying metadata including the channel identifier from the source signal stream. As used herein, the term “binding” refers to an identification of signals and content within a PO. PO's are frequently created for broad amounts of content that are not yet published (i.e., any show on TNT network in the evening).

When a show “airs” and a source signal stream is detected, the source signal stream is bound to the relevant PO's for that show.

At block 420, the server 302 (i.e., the CIS 310) generates a unique signal ID based on the temporal starting location of the advertisement signal point and the channel identifier. In one embodiment, the unique signal ID is a universally unique identifier (UUID). In an embodiment, the UUID may be at least 128 bits in length and may be generated by any suitable machine algorithm as would be appreciated by those skilled in the art having the benefit of this disclosure. At block 425, the server 302 (i.e., the CIS 310) inserts the unique signal ID into the metadata of the at least one source signal stream. From this point onward, the at least one source signal stream and one or more advertisement signal points in the at least one source signal stream may be uniquely identified for further processing. Examples of further processing may include determining advertisement placement decisions in associated recipient signal streams, lookback lookups, and generating and processing lookahead decision triggers for accelerating advertisement placement decisions.

In one embodiment, the unique signal ID may be inserted into the metadata of the at least one source signal stream using a designated in-band carriage format. The unique signal ID may be transformed as necessary in order to be carried in the source signal stream by whatever in band carriage mechanism is appropriate. For example, an in band carriage format of the source signal stream may need to be transformed from MPEG2 encoded format to MPEG4 format for delivery to an ADS 304a-304n associated with a smart appliance 308a-308n.

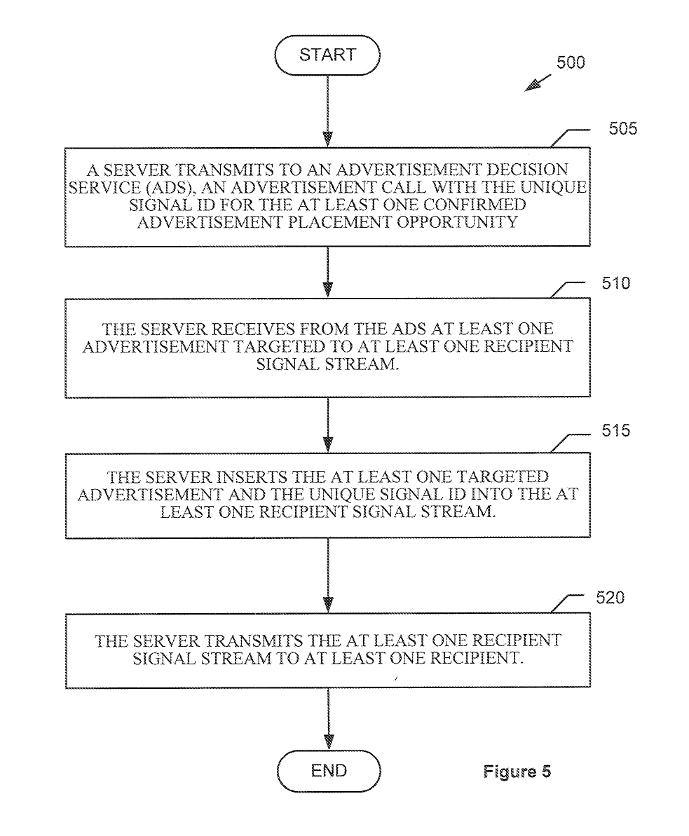

FIG. 5 is a flow diagram illustrating one embodiment of a method 500 for performing an advertisement decision for at least one confirmed advertisement placement opportunity, according to an embodiment of the present invention. At block 505, the server 302 transmits to an advertisement decision service (e.g., 304a), an advertisement call with the unique signal ID for the at least one confirmed advertisement placement opportunity. At block 510, the server 302 receives, from the advertisement decision service (e.g., 304a), at least one advertisement targeted to at least one recipient signal stream. At block 515, the server 302 inserts the at least one targeted advertisement and the unique signal ID into the at least one recipient signal stream. At block 520, the server 302 transmits the at least one recipient signal stream to at least one recipient (e.g., to the smart appliance 308a via the session manager 322 and the VOD pump (server) 326).

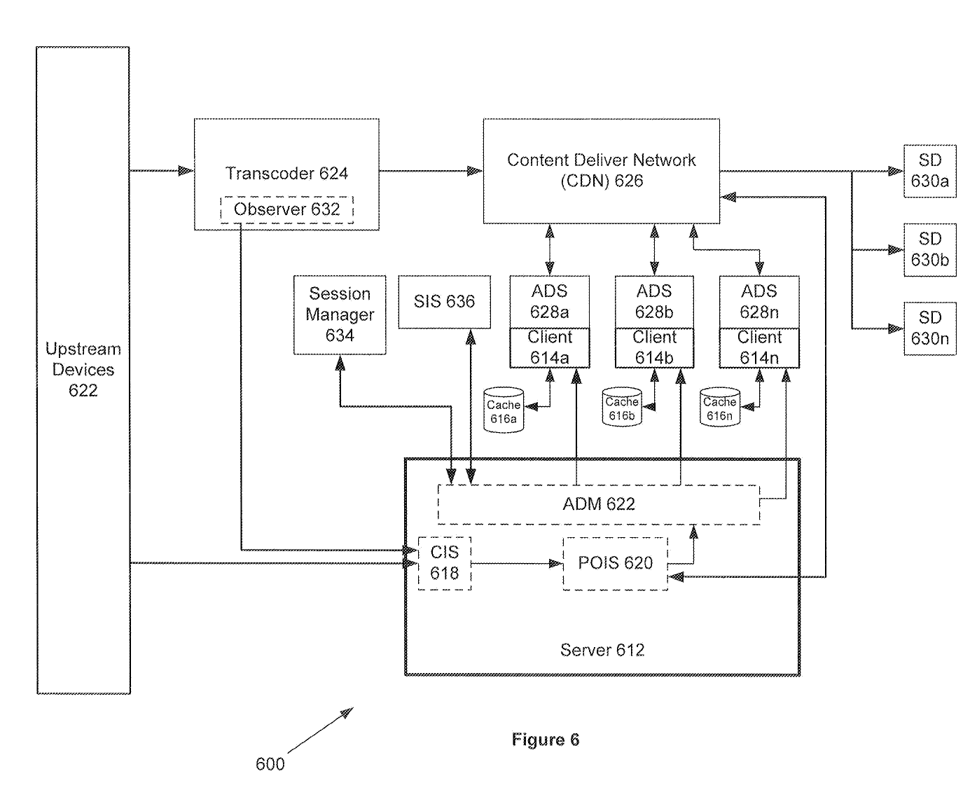

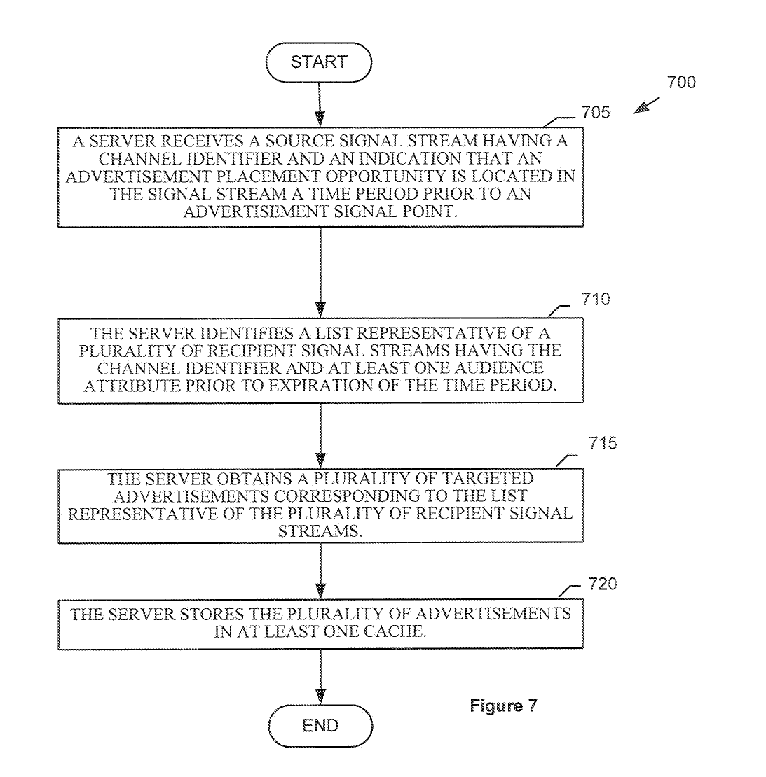

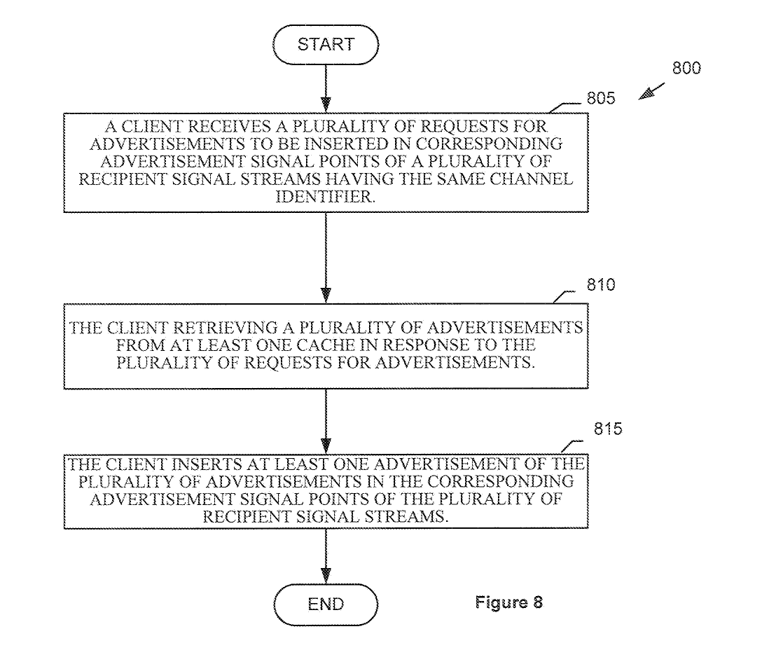

In one embodiment, the unique signal ID may be employed to accelerate placement decisions in associated recipient signal streams as illustrated in FIG. 6-8, which are reproduced from co-pending, commonly owned U.S. patent application Ser. No. 13/442,351 filed Apr. 9, 2012, the disclosure of which is incorporated herein by reference in its entirety. FIG. 6 depicts a configuration of a system 600 for accelerating advertising placement decisions in signal streams, according to an embodiment of the present invention. FIG. 7 is a flow diagram illustrating one embodiment of a method 700 for accelerating advertising placement decisions in signal streams from the point of view of a server, according to an embodiment of the present invention. FIG. 8 is a flow diagram illustrating one embodiment of a method 800 for accelerating advertising placement decisions in data streams from a point of view of one of a client, according to an embodiment of the present invention.

Referring now to FIG. 6, the system 600 may be executed on a server 612, interconnected by one or more networks (not shown) communicatively connected to client devices 614a-614n. The client devices 614a-614n are configured to store and retrieve a predetermined number of advertisements to/from corresponding caches 616a-616n for delivery to corresponding ADSs 628a-628n under the control of the server 612 and the CDN 626.

The server 612 is configured to implement a CIS 618 for receiving one or more source signal streams (e.g., digital video, audio, etc.) from upstream devices 622 and corresponding q-tones (i.e., instances of SCTE-35 packets) from one or more observers 634, which may be incorporated within a transcoder 624. The transcoder 624 is also configured to deliver IP video, audio, etc. in predetermined “chunks” to a CDN 626 as described above.

The CIS 618 is also configured to identify metadata from the one or more source signal streams and from these the server 612 is configured to pre-allocate a corresponding number of unconfirmed placement opportunities without signals and to bind the source signal stream to a plurality of premade, but unconfirmed placement opportunities. Part of the identified metadata includes a channel identifier associated with a corresponding source signal stream.

A POIS 620 is configured to “confirm” unconfirmed placement opportunities by identifying temporal starting locations of the unconfirmed placement opportunities relative to both the content stream and a wall clock. The CIS 618 is configured to return a globally unique value, a UUID, referred to as a signal identifier or signal ID that uniquely identifies a PO as a confirmed PO and its starting location within the end-to-end operational system. The CIS 618 then inserts the signal ID and the channel identifier into other identified metadata of the source signal stream using the appropriate in-band carriage format.

Referring now to FIGS. 6 and 7, at block 705, the CIS 618 associated with the server 612 receives a source signal stream (e.g., in MPEG-2 format) having a channel identifier from the upstream devices 622.

A transcoder 624 associated with a specific vendor format for the source signal stream (e.g., TBS) receives the signal stream and converts the signal stream to IP video. In the process, an observer 632, which may be include in transcoder 624, notes the presence of an SCTE-35 q-tone. In one embodiment, the indication that an advertisement placement opportunity is located in the signal stream is an instance of an SCTE-35 packet indicative of a q-tone. The q-tone also provides an indication that an advertisement placement opportunity is located in the signal stream a time period prior to an advertisement signal point in the signal stream. The observer 632 of the transcoder 624 then places a web call to the CIS 618 to inform the CIS 618 that the q-tone for a specific channel ID has been observed.

The arrival of the SCTE-35 packet is an indication of a number of theoretical advertisement placement opportunities (POs) for the specified channel ID (e.g., TBS). Each unconfirmed PO has an estimated starting location known as an advertisement signal point. The advertisement signal point needs to be confirmed. When an actual advertisement insertion starting location is encountered in real-time, a software process in the POIS 620 confirms the actual time of the advertisement signal point. This confirmed advertisement signal point results in the generation of confirmed POs that are now ready for advertisement insertion.

When the server 612 receives the theoretical placement opportunities, the server 612 is configured to pre-allocate a corresponding number of unconfirmed placement opportunities without signals and to bind the source signal stream to a plurality of premade, but unconfirmed placement opportunities. Binding the source signal stream to a plurality of premade, but unconfirmed placement opportunities includes the CIS 618 identifying metadata including the channel identifier from the source signal stream. As used herein, the term “binding” refers to an identification of signals and content within a PO. PO's are frequently created for broad amounts of content that are not yet published (i.e., any show on TNT network in the evening).

When a show “airs” and a source signal stream is detected, the source signal stream is bound to the relevant PO's for that show.

When confirmed POs are generated, the same signal point identifier that generated the POs is forwarded and captured by a listening ad decision resolution process in the ADM 622 associated with the server 612. This signal point forwarding is called the lookahead placement decision trigger (or decision trigger for short) that initiates a sequence of software processes. As content is acquired by the CDN 626, the CDN 626 notifies the POIS 620, and the POIS 620 “confirms” the temporal starting location of a placement opportunity relative to both the source signal stream and a wall clock. The POIS 620 returns a globally unique value, a UUID, referred to as a signal identifier or signal ID that uniquely identifies a PO as a confirmed PO and its starting location within the end-to-end operational system. The POIS 620 then inserts the signal ID and the channel identifier into other identified metadata of the source signal stream using the appropriate in-band carriage format.

In parallel, the POIS 620 initiates a workflow whereby the POIS 620 generates a set of confirmed placement opportunities in the source signal stream and fires a lookahead decision trigger with the signal ID as the trigger data. The lookahead decision trigger recipient is an instance of an SCTE 130 Ad Management Service, or the ADM 622 associated with the server 612.

At block 710, the ADM 622 of the server 612 identifies a list representative of a number of recipient signal streams having the channel identifier and at least one audience attribute prior to expiration of the time period. The list representative of a plurality of recipient signal streams having the channel identifier and at least one audience attribute corresponds to the number of confirmed placement opportunities. To identify the list, the ADM 622 places a call to the external session server 634 and to the external SIS 636. The ADM 622 transmits the channel identifier to the session manager 634, which provides the ADM 622 with a list of client identities indicative of a number of recipients currently viewing a channel corresponding to the channel identifier. The ADM 622 transmits the list of client identities and the channel identifier to the SIS 636 which provides the ADM 622 with a list of sets of audience qualifiers correlated to the client identities and the channel identifier. This list of sets of audience qualifiers correlated to the client identities and the channel identifier is representative of a list of recipient signal streams having the same channel identifier that are currently being “watched” by subscribers on the smart devices 630a-630n, where each subscriber in the list has a certain set of audience attributes (e.g., all males 21 and over).

At block 715, the ADM 622 of the server 612 obtains from one or more ADSs 628a-628n a plurality of targeted advertisements corresponding to the list sets of audience qualifiers correlated to the client identities and the channel identifier. The ADM 622 receives from the ADSs 628a-628n, the plurality of advertisements targeted to the list representative of the plurality of recipient signal streams.

At block 720, the ADM 622 of the server 612 stores the obtained targeted list of advertisements in at least one cache 616a-616n in the one or more ADSs 628a-628n. While storing the targeted list of advertisements in the in at least one cache 616a-616n, ADM 622 associates unique signal IDs with each of the targeted list of advertisements. Storing the obtained targeted list of advertisement in the at least one cache 616a-616n may include transmitting the targeted list of advertisements to at least one JAR (i.e., a Java archive) associated with the one or more clients 614a-614n. Since there may be thousands to millions of ads to be stored in the caches 616a-616n, in an embodiment, the ADM 622 divides the time interval from the reception of a q-tone to an expected arrival of the corresponding signal point in the source signal stream into a predetermined number of sub-time intervals and divides the number (i.e., the count) of received signal streams into a predetermined number of sub-signal streams. The predetermined number of sub-signal streams is distributed over the predetermined number of sub-time intervals to the caches 616a-616n associated with the clients 614a-614n.

Referring now to FIGS. 6 and 8, at block 805, a client (e.g., 614a), which is configured to control a cache (e.g., 616a), receives a predetermined number of requests from the CDN 626 for advertisements to be inserted in corresponding signal points of a number of recipient signal streams having the same channel identifier. At block 810, the client retrieves the predetermined number of advertisements from the cache (e.g., 616a). At block 815, the client 614a inserts the predetermined number of advertisements in the corresponding advertisement signal points of the predetermined number of recipient signal streams. The predetermined number of advertisements inserted in the corresponding advertisement signal points of a predetermined number of recipient signal streams occurs immediately subsequent to an identification of a corresponding signal point in a source signal stream by the ADM 622.

In-band insertion of a system wide unique signal ID based on a UUID at a confirmed signal start point permits an advertisement insertion point to be universally known throughout time. The unique signal ID may provide a primary key for locating advertisement placement opportunities, rendering matching by content asset and time unnecessary. The unique signal ID functioning as primary key speeds up advertisement decision processes and permits all aspects of advertisement decision resolution to reference the same unique value. Thus, a system becomes extremely fast.

For network DVR (nDVR), the unique signal ID may be stored along with date and time of acquisition, rendering look-back look-ups contextually well understood. Look-back look-ups may be indexed directly into tables by UUID rather than by relational or query based look-ups.

For example, a program may have been recorded on a Monday but is watched on a Wednesday. When the program is viewed, it becomes possible to look back in real time in the recorded program. If the program starts at 9:00 and a viewer begins watching the program 9:10 but missed the first 10 minutes, the system permits the viewer to “look back” 10 minutes into a live stream and then play forward so that the viewer is always chasing live time by 10 minutes. Advertisement placements are likewise 10 minutes initially out of date from real time. However, having a UUID to identify a corresponding advertisement starting point in a particular recipient signal stream permits nearly real-time advertisement insertion into the recipient signal stream.

FIG. 9 illustrates a diagrammatic representation of a machine in the exemplary form of a computer system 900 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processing device 902, a main memory 904 (e.g., read-only memory (ROM), flash memory, dynamic random access memory (DRAM) (such as synchronous DRAM (SDRAM) or Rambus DRAM (RDRAM), etc.), a static memory 906 (e.g., flash memory, static random access memory (SRAM), etc.), and a data storage device 918, which communicate with each other via a bus 930.

Processing device 902 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. Processing device 902 is configured to execute the server 302, communicatively connected for performing the operations and steps discussed herein.

Computer system 900 may further include a network interface device 908. Computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 916 (e.g., a speaker).

Data storage device 918 may include a machine-readable storage medium (or more specifically a computer-readable storage medium) 920 having one or more sets of instructions 922 (e.g., the server 302) embodying any one or more of the methodologies of functions described herein. The server 302 may also reside, completely or at least partially, within main memory 904 and/or within processing device 902 during execution thereof by computer system 900; main memory 904 and processing device 902 also constituting machine-readable storage media. The server 302 may further be transmitted or received over a network 926 via network interface device 908.

Machine-readable storage medium 920 may also be used to store the device queue manager logic persistently. While machine-readable storage medium 920 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling”, “transmitting”, “requesting”, “identifying”, “querying”, “retrieving”, “forwarding”, “determining”, “passing”, “processing”, “disabling”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A computer-implemented method of marking signal streams for advertisement placement, said method comprising the steps of:
receiving, using a programmed computer, at least one source signal stream having a channel identifier;
identifying, using the programmed computer, an advertisement signal point in the at least one source signal stream;
determining, using the programmed computer, a temporal starting location of the advertisement signal point;
generating, using the programmed computer, a unique signal ID based on the temporal starting location of the advertisement signal point and the channel identifier; and
inserting, using the programmed computer, the unique signal ID into metadata of the at least one source signal stream.

2. The method of claim 1, wherein the unique signal ID is a universally unique identifier (UUID).

3. The method of claim 2, wherein the universally unique identifier of at least 128 bits in length.

4. The method of claim 1, wherein the unique signal ID is inserted into the metadata of at least one source signal stream using a designated in-band carriage format.

5. The method of claim 1, wherein the temporal starting location of an advertisement signal point is determined based on a wall clock time stamp.

6. The method of claim 1, wherein the step of identifying an advertisement signal point in the at least one source signal stream comprises receiving an instance of an SCTE-35 packet indicative of a cue tone.

7. The method of claim 1, further comprising generating at least one theoretical advertisement placement opportunity based on the identified advertisement signal point.

8. The method of claim 7, further comprising obtaining at least one confirmed advertisement placement opportunity from the at least one theoretical advertisement placement opportunity.

9. The method of claim 8, wherein obtaining the at least one confirmed advertisement placement opportunities from the at least one theoretical advertisement placement opportunity comprises:
pre-allocating at least one premade, but unconfirmed advertisement placement opportunity without signals;
binding the source signal stream to at least one premade, but unconfirmed advertisement placement opportunity; and
designating the at least one premade, but unconfirmed advertisement placement opportunity as confirmed advertisement placement opportunity.

10. The method of claim 8, further comprising performing an advertisement decision for the at least one confirmed advertisement placement opportunity.

11. The method of claim 10, wherein performing an advertisement decision for the at least one confirmed advertisement placement opportunity comprises transmitting, to an advertisement decision service, an advertisement call with the unique signal ID for the at least one confirmed advertisement placement opportunity.

12. The method of claim 11, wherein performing an advertisement decision for at least one confirmed placement opportunity comprises further comprises:
receiving, from the advertisement decision service, at least one advertisement targeted to at least one recipient signal stream;
inserting the at least one targeted advertisement and the unique signal ID into the at least one recipient signal stream; and
transmitting the at least one recipient signal stream to at least one recipient.

13. The method of claim 1, further comprising employing the temporal starting location of the advertisement signal point with the unique signal ID to perform a lookback lookup.

14. The method of claim 1, further comprising generating a look-ahead decision trigger with the unique signal ID as trigger data.

15. The method of claim 14, further comprising transmitting to an advertisement decision service an advertisement call with the unique signal ID for at least one confirmed advertisement placement opportunity.

16. The method of claim 15, wherein, in response to transmitting to an advertisement decision service an advertisement call with the unique signal ID, performing an advertisement decision for at least one confirmed placement opportunity.

17. The method of claim 16, wherein performing an advertisement decision for at least one confirmed placement opportunity comprises:
receiving, from the advertisement decision service, at least one advertisement targeted to at least one recipient signal stream;
inserting the at least one targeted advertisement and the unique signal ID into the at least one recipient signal stream; and
storing the at least one targeted advertisement in a cache.

18. The method of claim 17, wherein storing the at least one targeted advertisement in a cache comprises transmitting the at least one targeted advertisement to at least one JAR associated with a content delivery network.

19. The method of claim 1, wherein the at least one source signal stream comprises content.

20. The method of claim 19, wherein content comprises video, audio, or an interactive overlay.

21. The method of claim 20, wherein a time interval associated with the advertisement signal point in the at least one source signal stream corresponds to breaks, pre-rolls, post-rolls, mid-rolls, interstitials, pauses, or video-on-demand requests.

22. A computer system for marking signal streams for advertisement placement, comprising:
a memory;
a processing device, coupled to the memory, the processing device configured to:
receive at least one source signal stream having a channel identifier;
identify an advertisement signal point in the at least one source signal stream;
determine a temporal starting location of the advertisement signal point;
generate a unique signal ID based on the temporal starting location of the advertisement signal point and the channel identifier; and
insert the unique signal ID into metadata of the at least one source signal stream.

23. A non-transitory computer readable storage medium including instructions that, when executed by a processing system, causes the processing system to perform a method of marking signal streams for advertisement placement, comprising:
receiving at least one source signal stream having a channel identifier;
identifying an advertisement signal point in the at least one source signal stream;
determining a temporal starting location of the advertisement signal point;
generating a unique signal ID based on the temporal starting location of the advertisement signal point and the channel identifier; and
inserting the unique signal ID into metadata of the at least one source signal stream.
